(19) United States
(12) Patent Application Publication
(10) Pub. No.: US 2024/0344370 A1
(43) Pub. Date: Oct. 17, 2024

(54) BLIND CONNECTION SYSTEM FOR A REMOTE ACTUATOR

(71) Applicant: MAGNA CLOSURES INC., Newmarket (CA)

(72) Inventors: Mario CAPPELLI, Newmarket (CA); Enrico MARGHERITTI, Newmarket (CA)

(21) Appl. No.: 18/606,491

(22) Filed: Mar. 15, 2024

Related U.S. Application Data
(60) Provisional application No. 63/452,597, filed on Mar. 16, 2023.

(51) Int. Cl. E05B 79/20; E05B 85/02

(52) U.S. Cl. CPC E05B 79/20; E05B 85/02

(57) ABSTRACT

An actuation system for coupling with a latch, the system comprising: a housing having a receptacle, the housing containing an actuator arm moveable within an interior of the housing, the actuator arm having a first connection feature; a cover plate for installing in the receptacle, the cover plate for aligning the first connection feature with a second connection feature; a cable apparatus mounted on the cover plate, the cable apparatus having the second connection feature such that the second connection is suitable for engagement with the first connection feature; wherein insertion of the cover plate in the receptacle causes an operative coupling of the cable apparatus with the actuator arm by aligning and mating the first connection feature with the second connection feature.

### CROSS-REFERENCE TO RELATED APPLICATION

This application claims the benefit of U.S. Provisional Application Ser. No. 63/452,597, filed Mar. 16, 2023, which is incorporated herein by reference in its entirety.

### FIELD

This disclosure relates to latch mechanisms and actuation.

### BACKGROUND

Some vehicles are equipped with a closure panel, such as a lift gate, which is driven between an open position (position 2) and a closed position (position 1) using an electrically driven lift or opening system, as well as an operated latch. The latch can be operated by a remote actuator and thus operative coupling of the latch with the remote actuator is needed during installation in the vehicle. Disadvantages of current installation of coupling between the actuator and latch include the need to visually see the mating of their coupling, which can be problematic in tight spaces and confined packaging during the installation.

Further, in assembly operations for combined actuator and latch type systems, the use of a coverplate is beneficial to protect against environmental contamination (e.g. water, dirt, etc.) and subsequent damage to sensitive mechanisms and electronics. Therefore, it is recognized that coverplates can also obscure important visual access and also block physical access to mating components during assembly.

### SUMMARY

It is an object of the present invention to provide an actuation system for a latch that obviates or mitigates at least one of the above presented disadvantages.

One aspect provided is an actuation system for coupling with a latch, the system comprising: a housing having a receptacle, the housing containing an actuator arm moveable within an interior of the housing, the actuator arm having a first connection feature; a cover plate for installing in the receptacle, the cover plate for aligning the first connection feature with a second connection feature; a cable apparatus mounted on the cover plate, the cable apparatus having the second connection feature such that the second connection is suitable for engagement with the first connection feature; wherein insertion of the cover plate in the receptacle causes an operative coupling of the cable apparatus with the actuator arm by aligning and mating the first connection feature with the second connection feature.

A second aspect provided is an actuation system for coupling with a latch, the system comprising: a housing supporting an actuator arm moveable relative the housing, the actuator arm having a first connection feature having a first dimension; a cable apparatus having the second connection feature having a second dimension; wherein the first connection feature and the second connection feature are engageable with one another when the first dimension and the second dimension correspond and wherein the first connection feature and the second connection feature are not engageable with one another when the first dimension and the second dimension do not correspond.

A third aspect provided is an actuation system for coupling with a latch, the system comprising: a housing supporting an actuator arm moveable relative the housing, the actuator arm having a first connection feature having a first shape; a cable apparatus having the second connection feature having a second shape; wherein the first connection feature and the second connection feature are engageable with one another when the first shape and the second shape correspond and wherein the first connection feature and the second connection feature are not engageable with one another when the first shape and the second shape do not correspond.

The system further comprising the first connection is a pin and the second connection feature is a ring with a corresponding hole.

The system further comprising the first connection feature having a tapered wall for facilitating the alignment of the connection features and their mating.

The system further comprising the second connection feature having a tapered wall for facilitating the alignment of the connection features and their mating.

The system further comprising the first connection is a ring with a corresponding hole and the second connection feature is a pin.

The system further comprising a holder for mounting the second connection feature to an underside of the cover plate.

The system further comprising a slot in the holder, such that the slot facilitates lateral movement of the second connection feature with respect to an insertion direction of the cover plate when coming into engagement with the receptacle.

The system wherein an insertion direction of the cover plate into the receptacle is provided as transverse to an axis of the cable of the cable apparatus.

The system further comprising a holder for mounting the second connection feature to an underside of the cover plate.

The system further comprising a slot in the holder, such that the slot facilitates lateral movement of the second connection feature with respect to an insertion direction of the cover plate when coming into engagement with the receptacle.

The system further comprising one or more releasable fasteners positioned on at least one of the cover plate and the housing.

The system wherein the one or more releasable fasteners resilient tabs for coupling with corresponding slots.

The system further comprising at least one of a respective shape and a respective size between the first connection feature and the second connection feature provides for a suitable key and lock configuration for said engagement.

The system wherein the mating surface of first connection feature is of a selected shape compatible with a corresponding shape of the mating surface of the second connection feature.

The system wherein the mating surface of first connection feature is of a selected size compatible with a corresponding size of the mating surface of the second connection feature.

Other aspects, including methods of operation, and other embodiments of the above aspects will be evident based on the following description and drawings.

### BRIEF DESCRIPTION OF THE DRAWINGS

Reference is made, by way of example only, to the attached figures, wherein:

FIG. 1 is a component view of a latch and actuator system with a housing;

FIG. 2 is an unassembled view of a cable apparatus of the latch and actuator system of FIG. 1;

FIG. 3 is an assembled view of the cable apparatus of the latch and actuator system of FIG. 2;

FIG. 4 shows a perspective view of the cable apparatus of FIG. 1;

FIG. 5 is a cross sectional view of the cable apparatus and housing of FIG. 2 in an unassembled position;

FIG. 6 is a cross sectional view of the cable apparatus and housing of FIG. 2 in an assembled position;

FIGS. 7a,b,c,d shows an example installation procedure of the cable apparatus of FIG. 1;

FIGS. 8a,b show example operation of the installed cable apparatus of FIG. 1;

FIG. 9 shows an enlarged view of the cable apparatus of FIG. 4; and

FIG. 10 is an example perspective view of a latch of FIG. 1.

### DETAILED DESCRIPTION OF EXAMPLE EMBODIMENTS

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments. Likewise, use of a plural form in reference to an item is not intended to exclude the possibility of including one of the item in some embodiments. It will be apparent to one skilled in the art in at least some instances in this specification and the attached claims that it would be possible to include one of the item in at least some embodiments.

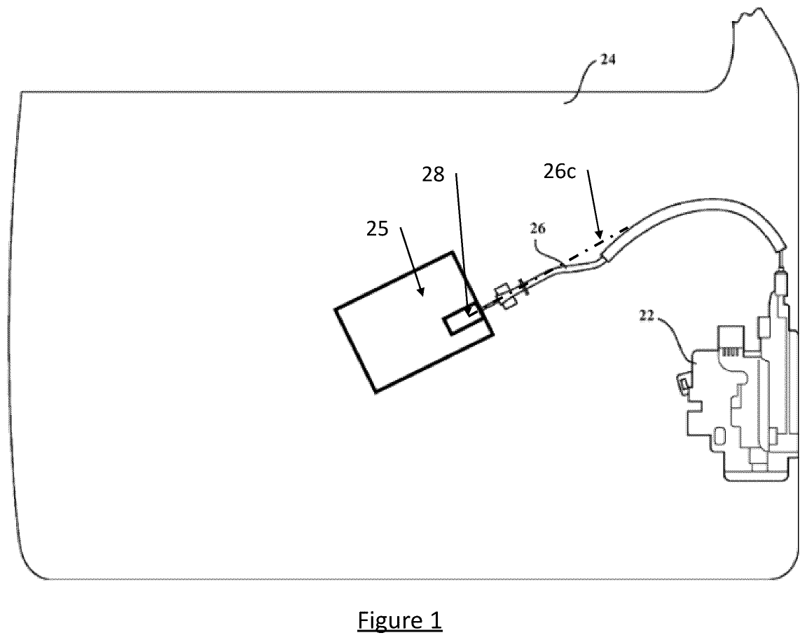

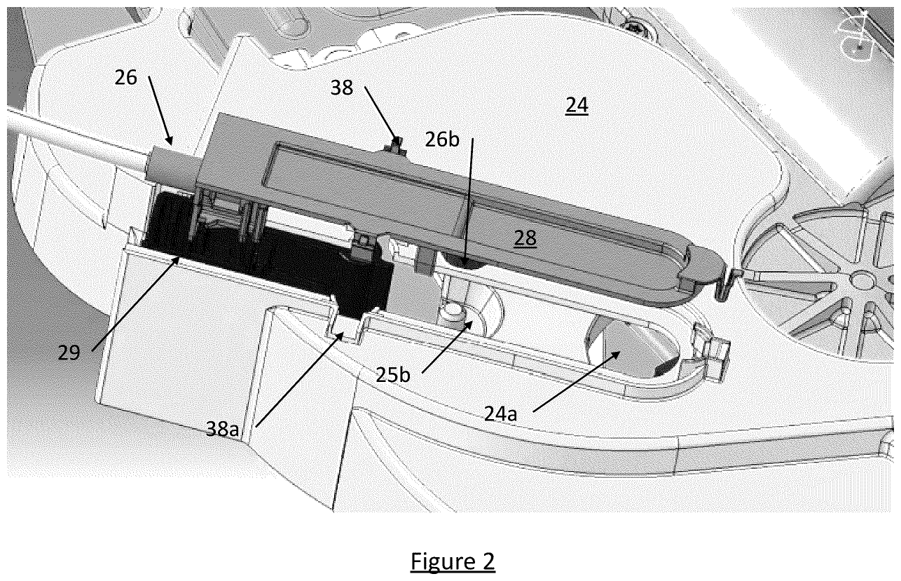

Referring to FIG. 1, shown is a housing 24 for containing in an interior 24a (see FIG. 2) a remote actuator 25 (for example) coupled to a latch 22 (e.g. a cinching latch). The remote actuator 25 is coupled mechanically to the latch 22 by a cable apparatus 26, e.g. a Bowden cable. Also shown is a cover plate 28 for engaging with a receptacle 29 of the housing, such that the cable apparatus 26 is connected to one side (e.g. interior side) of the cover plate 28. The cover plate 28 is useful for covering and thus protecting the assembled mechanism from foreign matter contamination during in vehicle operation of the remote actuator 25, in particular in protecting and/or sealing of the connection with the cable apparatus 26. As such, installation of the cover plate 28 with the receptacle 29 of the housing 24 positions and subsequently protects the cable apparatus 26 in the interior 24a of the housing 24, adjacent the remote actuator 25 (or at least a portion of the remote actuator 25). It is recognised that the latch 22 can be installed in a vehicle (not shown), such that the latch can be used to retain a closure panel (e.g. door, hood, trunk, seat, etc. —not shown) in a closed or locked position.

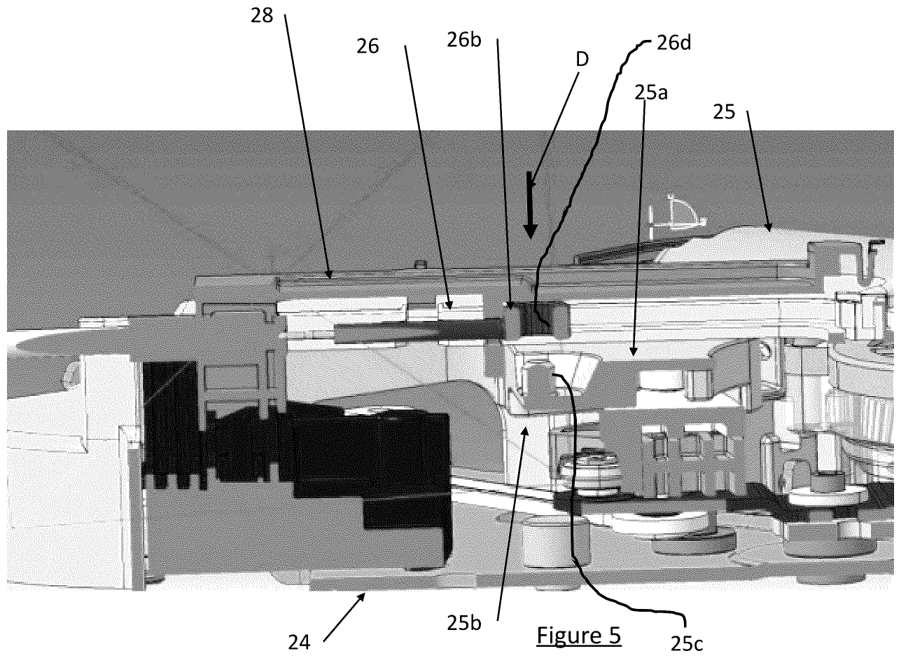

For example, the remote actuator 25 can be a motor coupled to a side of the housing 24, while an actuator arm 25a (see FIG. 5) positioned in the interior 24a can be connected to the actuator 25 and thus operable by the actuator 25 (e.g. motor). Installation of the cover plate 28 advantageously provides for positioning a portion of the cable apparatus 26 adjacent to, and into, engagement with a portion of the remote actuator 25, as further described below. Remote actuator 25 may be illustratively configured to cinch the latch 22 from an open position to a closed position. An example of a remote cinch actuator having an output lever to is shown in U.S. patent Ser. No. 11/168,497 titled “Power actuator with self disengaging clutch unit”, the entire contents of which are incorporated herein by reference. Remote actuator 25 may be configured to cinch or actuate a frunk latch for a frunk closure panel as shown and described in US Patent Application No. 20200318400 titled “Power actuator having cam-driven dual cable actuation mechanism for use with vehicular closure latch assembly”, the entire contents of which are incorporated herein by reference. Remote actuator 25 may be employed to activate other vehicle systems such as a pop-up hood spring system as shown in US Patent Application No. 20230220713 titled “Driven spring system for hood”, the entire contents of which are incorporated herein by reference.

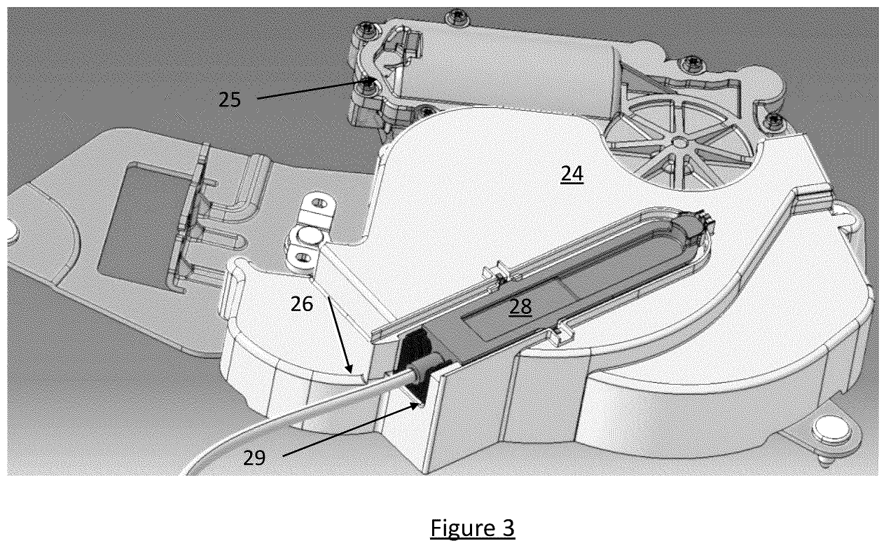

Referring again to FIG. 5, the actuary arm 25a includes a first connection feature 25b for coupling with a corresponding second connection feature 26b of the cable apparatus 26. For example, the first connection feature 25b can be configured (e.g. positioned and/appropriately shaped/sized) to facilitate a desired blind assembly of the connection features 25b, 26b to one another, once the cover plate 28 is installed in the receptacle 24a, such that FIGS. 2, 5 show the cover plate 28 uninstalled (hence the connection features 25b,26b are spaced apart and thus are uncoupled) while FIGS. 3,6 show the cover plate 28 installed on the housing 24 and thus the first and second connection features 25b, 26b are coupled with one another. In other words, the process of installing the requisite cover plate 28 also provides at the same time the desired inter-coupling of the connection features 25b, 26b.

It is recognised that once the connection features 25b, 26b are coupled to one another, then the actuator 25 (e.g. via the actuator arm 25a) can operate the connected cable apparatus 26. Using the cable apparatus 26, the actuator 25 can operate/manipulate components of the latch 24, as further provided below by example.

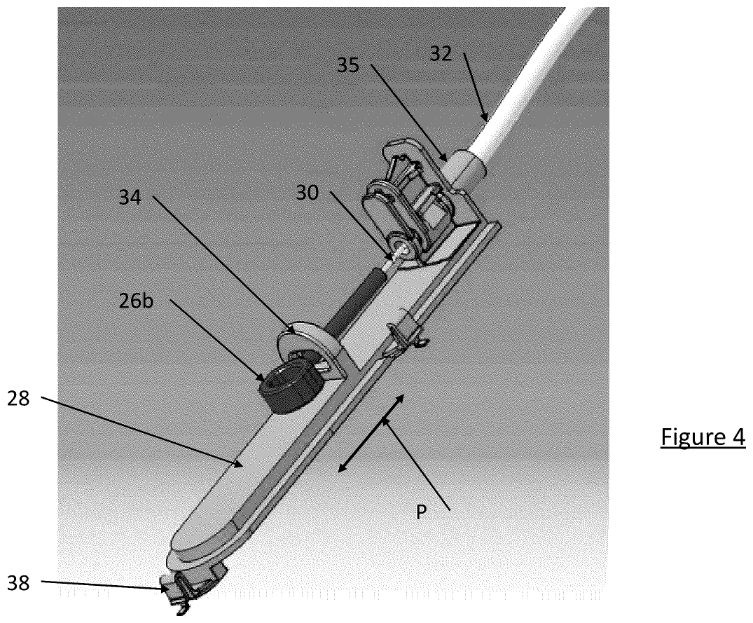

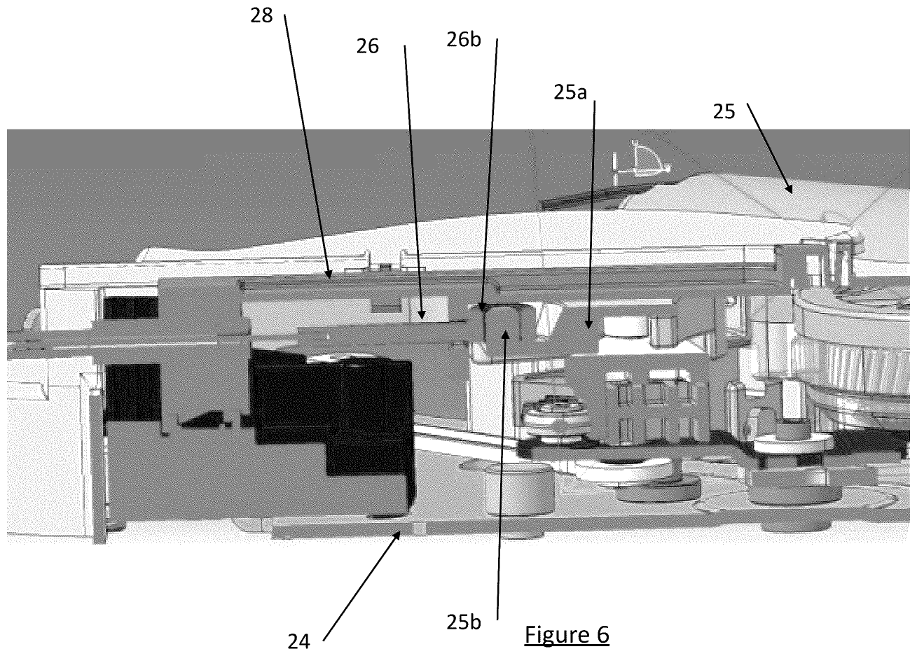

Referring to FIG. 4, the cable assembly includes a cable 30, a sleeve 32, a connector 35 for connecting/mounting the sleeve 32 to the cover plate 28, the second connection feature 26b (e.g. a ring or ferrule) connected on an end of the cable 30 and an optional holder 34 (e.g. slot) for guiding movement of the second connection feature 26b during operation of the remote actuator 25 (and thus facilitating movement of the cable 30 within the sleeve 32 when the connection features 25b, 26b are connected with one another—see FIG. 6). For example, the retention mechanism/holder 34 for the cable 30 can be used to inhibit the cable 30 from sagging into housing interior 24a during insertion of the cover plate 28 into the receptacle 29, but allows side to side movement during release lever 50 activation, see FIG. 10, i.e. via movement of the actuator arm 25a by the remote actuator 25.

Referring again to FIG. 4, the cover plate 28 also has one or more fasteners 38, e.g. clips, for releasably connecting the cover plate 28 to the housing 24. As shown, one example of the releasable fasteners 38 could be resilient tabs 38 for coupling with corresponding slots 38a in the housing 24. Referring to FIG. 2, it can be seen that once the cover plate 28 is positioned adjacent to the receptacle 29, the connection features 25b, 26b are adjacent and spaced apart from one another but are also in alignment. As such, once aligned, insertion (e.g. in a lateral motion D transverse to the axis 26c of the cable of the cable apparatus 26) of the cover plate 28 into the receptacle 29 provides for coupling of the connection features 25b, 26b with one another. It is recognised that advantageously, the installer of the cover plate 28 (and thus the cable apparatus 26) does not have a direct line of sight to the mating of the connection features 25b, 26b, rather the installer relies upon the relative alignment of the connection features 25b, 26b proved by proper mounting of the cable apparatus 26 on the cover plate 28 as well as proper positioning of the first connection feature 26b in the housing 24 and thus relative to the receptacle 29.

It is recognized that differently configured (e.g. size, shape) remote actuators 25 and cover plates 28 can be envisioned, as well as differently (e.g. size, shape) configured connection features 25b, 26b, especially when manufacturing tolerances are taken into consideration of these components 25, 28, 25b, 26b.

In this example manner of inserting the cover 28, connection of the releasable fasteners 38 with the corresponding ones 38a of the housing provides for desirable alignment and thus mating of the connection features 25b, 26b in the interior 24a of the housing 24. For example, FIG. 2 shows the second connection feature 26b of the cable apparatus 26 aligned with the first connection feature 25b of the actuator arm 25a (e.g. release lever), such that moving of the cover plate transversely to the housing 24 can result in appropriate mating of the connection features 25b,26b without needing direct line of sight and/or physical access to the interior 24a of the housing by the installer during the assembly process of the connection features 25b,26b. For example, the actuator arm 25 is shown in its home or unactuated position.

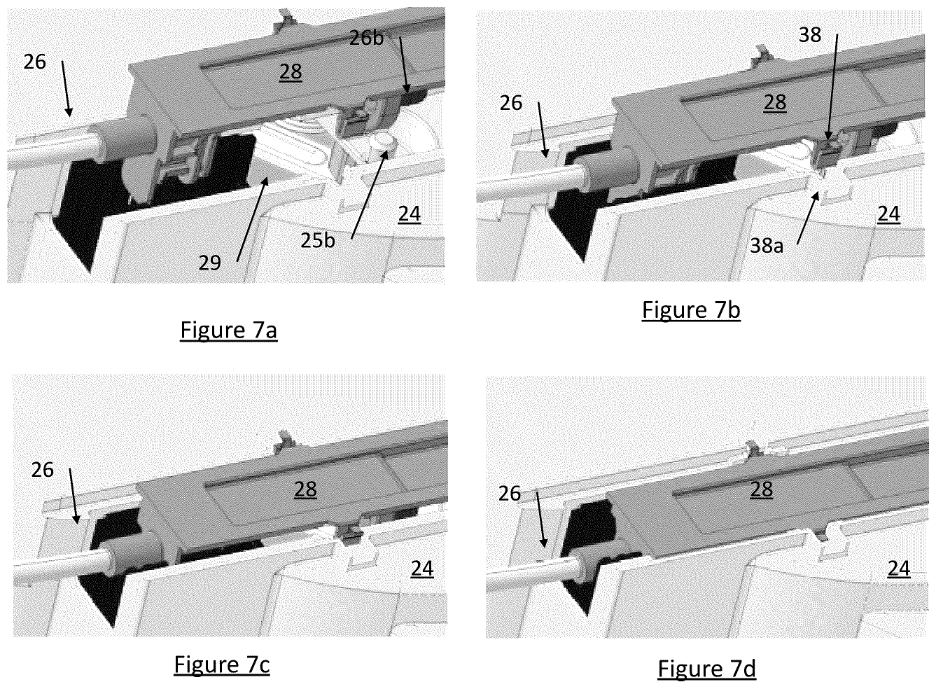

Referring to FIGS. 7a, 7b, 7c, 7d, shown is a coupling sequence (e.g. assembly process) for the connection features 25b, 26b. FIG. 7a shows the cover plate 28 initially positioned above the receptacle 29 (e.g. in a position spaced apart and positioned for transverse movement D to the axis 26c of the cable 26—see FIGS. 1, 5) and thus placing into alignment the connection features 25b, 26b. FIG. 7b then shows the cover plate 28 positioned so as to begin engagement of the releasable fasteners 38, 38a. FIG. 7c shows blind engagement of the aligned connection features 25b, 26b as the cover plate 28 is further inserted into the receptacle 29 in the direction D, and FIG. 7d shows the assembled cover plate 28 and housing 24, such that the connection features 25b, 26b are operatively coupled with one another (also see FIG. 6).

Also, as shown in FIG. 5, during installation of the cover plate 28, an insertion direction D is such that the second connection feature 26b (e.g. ferrule) is in its correct alignment with the first connection feature 26b (e.g. release lever connection feature). Further, the first connection feature 25b can have sloped walls 25c, e.g. tapered, so as to assist in insertion of the second connection feature 26b into the first connection feature 26b and thus facilitate coupling/mating of the connection features 25b, 26b as the cover plate 28 is installed in the insertion direction D into the receptacle 29. Further, the second connection feature 26b can have sloped walls 26d, e.g. tapered, so as to assist in insertion of the first connection feature 25b into the second connection feature 26b and thus facilitate coupling/mating of the connection features 25b, 26b as the cover plate 28 is installed in the insertion direction D into the receptacle 29.

Referring to FIGS. 4 and 5, shown is that a position of the second connection feature 26b along the axis 26c can be moved in direction(s) P (e.g. in a direction along the axis 26c) with respect to the holder 34. Thus the distance of the second connection feature 26b with respect to the holder 34 can be adjusted (e.g. by pushing or pulling on the cable 30 within the sleeve 32) during the assembly process of the cover plate 28 with the receptacle 29.

Furthermore, the mateable configurations of second connection feature 26b (e.g. ferrule) with the first connection feature 25b can inhibit connection of a differently sized second connection feature 26b with the first connection feature 25b to facilitate the correct assembly of components. For example another cable apparatus having a longer length than cable 26 intended for another application such as a lock/unlock control for a different latch and having a connection feature (e.g. ferrule) that is enlarged for correct engagement another appropriately dimensioned first connection feature (e.g. pin and slot) would not be able to engage with the first connection feature 25b of latch 22 if an assembler has incorrectly selected the another cable apparatus. As a result, a first connection feature 25b and second connection feature 26b provide a keyed interface dimensioned for engagement only with each other to facilitate the attachment of designated cables to the correct latch 22. In this manner, similar to a key and lock analogy, e,g, a unique combination pertaining to the fit compatibility of the walls 25c, 26d with respect to one another based on at least one of shape and/or size, the sizing/shaping of the walls 25c, 26d can be configured so as to be compatible only with each other uniquely, and thus facilitate the correct selection and assembly of the proper cable apparatus 26 suitable for the selected actuator 25. In other words, the walls 25c, 26d of the connection features 25b, 26b uniquely correspond with one another in terms of at least one of size (e.g. dimension(s)) and shape.

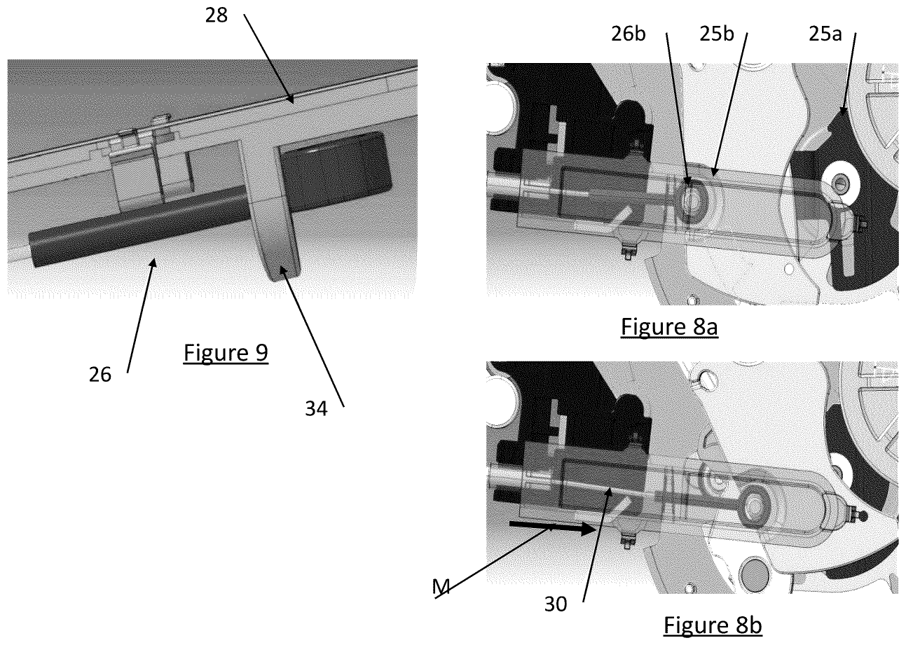

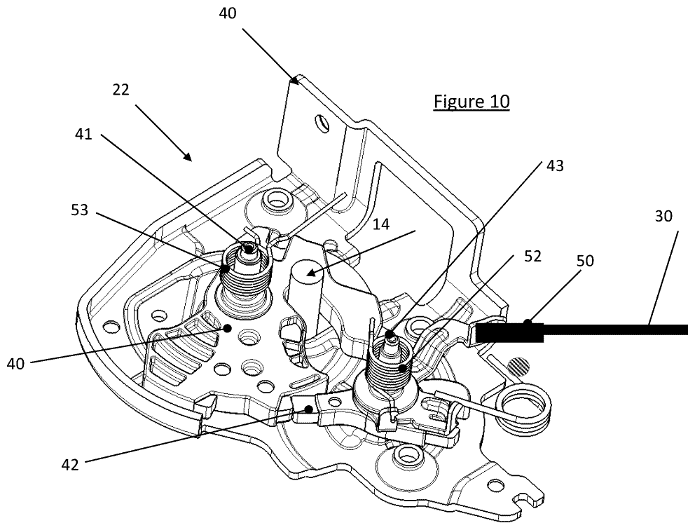

Referring to FIGS. 8a, 8b, shown is the coupled connection features 25b, 26b in operation, such that movement of the actuator arm 25 moves M the cable 30. FIG. 9 shows an enlarged view of the cable apparatus 26 installed on the cover plate 28. For example, the holder 34 (e.g. mounted on an underside of the cover plate 28) can be part of the cover plate 28, as desired.

Referring to FIG. 10, shown is an example latch 22 including a ratchet 40 and a pawl 42, such that the pawl 42 retains the ratchet 40 in a latched position (i.e. holding a mating latch component 14 within a slot of the ratchet 40). In this figure, the pawl 42 is shown in a closed position, such that a pawl surface is in contact with a ratchet surface, thus maintaining the ratchet in the closed/locked position while these surfaces are in contact. The ratchet 40 pivots about a ratchet pivot axis 41 and the pawl 42 pivots about a pawl pivot axis 43, for example, as the latch 22 is operated between the latched position (shown) and an unlatched position (i.e. when the mating latch component 14 is allowed to exit the slot). The ratchet 40 and the pawl 42 are mounted to the housing 24 (for example), such that the ratchet 40 is based towards the open position by a ratchet biasing element (e.g. spring) 53. Further, the pawl 42 is biased towards contact with the ratchet 40 via a pawl biasing element (e.g. spring) 52. For example, it is recognized that movement of the pawl 42 about the pawl pivot 43 (e.g. by manipulation of an actuator/release lever 50 such as by example via movement of the attached cable 30 as is known in the art) causes the pawl 42 to disengage from the ratchet 40 and thus facilitate the ratchet 40 to pivot about the ratchet pivot 41 and thus allow the mating latch component 14 to exit the slot. Similarly, restricting movement of the pawl 42 about the pawl pivot 43 (e.g. by the pawl biasing element 52 such as a torsion spring as is known in the art) causes the pawl 42 to maintain engagement with the ratchet 40 and thus inhibit the ratchet 40 to pivot about the ratchet pivot 41 and thus retain the position of the mating latch component 14 within the slot.

We claim:

1. An actuation system for coupling with a latch, the system comprising:
a housing having a receptacle, the housing containing an actuator arm moveable within an interior of the housing, the actuator arm having a first connection feature;
a cover plate for installing in the receptacle, the cover plate for aligning the first connection feature with a second connection feature;
a cable apparatus mounted on the cover plate, the cable apparatus having the second connection feature such that the second connection feature is suitable for engagement with the first connection feature;
wherein insertion of the cover plate in the receptacle causes an operative coupling of the cable apparatus with the actuator arm by aligning and mating the first connection feature with the second connection feature.

2. The system of claim 1, wherein the cover plate visually obscures the mating of the first connection feature with the second connection feature during the insertion of the cover plate in the receptacle.

3. The system of claim 1, wherein the cable apparatus has one end of a cable connected to the second connection feature and another end of the cable connected to the latch.

4. The system of claim 1, wherein the first connection feature is positioned on the actuator arm which is connected to a motor of an actuator, such that the actuator is located remote to the latch.

5. The system of claim 4, wherein the actuator is mounted adjacent the housing.

6. The system of claim 1 further comprising the first connection is a pin and the second connection feature is a ring with a corresponding hole.

7. The system of claim 1 further comprising the first connection feature having a tapered wall for facilitating the alignment of the connection features and their mating.

8. The system of claim 1 further comprising the second connection feature having a tapered wall for facilitating the alignment of the connection features and their mating.

9. The system of claim 1 further comprising the first connection is a ring with a corresponding hole and the second connection feature is a pin.

10. The system of claim 1 further comprising a holder for mounting the second connection feature to an underside of the cover plate.

11. The system of claim 10 further comprising a slot in the holder, such that the slot facilitates lateral movement of the second connection feature with respect to an insertion direction of the cover plate when coming into engagement with the receptacle.

12. The system of claim 3, wherein an insertion direction of the cover plate into the receptacle is provided as transverse to an axis of the cable of the cable apparatus.

13. The system of claim 12 further comprising a holder for mounting the second connection feature to an underside of the cover plate.

14. The system of claim 13 further comprising a slot in the holder, such that the slot facilitates lateral movement of the second connection feature with respect to an insertion direction of the cover plate when coming into engagement with the receptacle.

15. The system of claim 1 further comprising one or more releasable fasteners positioned on at least one of the cover plate and the housing.

16. The system of claim 15 wherein the one or more releasable fasteners resilient tabs for coupling with corresponding slots.

17. The system of claim 1 further comprising at least one of a respective shape and a respective size between the first connection feature and the second connection feature provides for a suitable key and lock configuration for said engagement.

18. The system of claim 17, wherein the mating surface of first connection feature is of a selected shape compatible with a corresponding shape of the mating surface of the second connection feature.

19. The system of claim 17, wherein the mating surface of first connection feature is of a selected size compatible with a corresponding size of the mating surface of the second connection feature.

20. An actuation system for coupling with a latch, the system comprising:
a housing supporting an actuator arm moveable relative the housing, the actuator arm having a first connection feature having a first dimension;
a cable apparatus having the second connection feature having a second dimension;
wherein the first connection feature and the second connection feature are engageable with one another when the first dimension and the second dimension correspond and wherein the first connection feature and the second connection feature are not engageable with one another when the first dimension and the second dimension do not correspond.
